(19) United States
(12) Patent Application Publication
(10) Pub. No.: US 2019/0070877 A1
(43) Pub. Date: Mar. 7, 2019

(54) Frame Hanging Guide Device

(71) Applicant: Derrick Flores, Austin, TX (US)

(72) Inventor: Derrick Flores, Austin, TX (US)

(21) Appl. No.: 15/696,593

(22) Filed: Sep. 6, 2017

(51) Int. Cl. B41K 1/00; A47G 1/20

(52) U.S. Cl. CPC B41K 1/003; A47G 1/205

(57) ABSTRACT

A frame hanging guide device for indicating an attachment point for a frame includes a housing that is configured to reversibly couple by a first end to a back of a frame, such as picture frame. The housing defines an interior space. The housing has a second end that is open. An indicator is positioned in the interior space. The indicator is selectively extensible from the housing. The indicator is configured to mark an attachment point on a surface as the frame is positioned in a desired location on the surface. An article of mounting hardware can be coupled to the surface at the attachment point to hang the frame.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to guide devices and more particularly pertains to a new guide device for indicating an attachment point for a frame.

### BRIEF SUMMARY OF THE INVENTION

An embodiment of the disclosure meets the needs presented above by generally comprising a housing that is configured to reversibly couple by a first end to a back of a frame, such as picture frame. The housing defines an interior space. The housing has a second end that is open. An indicator is positioned in the interior space. The indicator is selectively extensible from the housing. The indicator is configured to mark an attachment point on a surface as the frame is positioned in a desired location on the surface. An article of mounting hardware can be coupled to the surface at the attachment point to hang the frame.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a frame hanging guide device according to an embodiment of the disclosure.

FIG. 2 is a side view of an embodiment of the disclosure.

FIG. 3 is a top view of an embodiment of the disclosure.

FIG. 4 is a bottom view of an embodiment of the disclosure.

FIG. 5 is an exploded view of an embodiment of the disclosure.

FIG. 6 is a cross-sectional view of an embodiment of the disclosure.

FIG. 7 is a cross-sectional view of an embodiment of the disclosure.

### DETAILED DESCRIPTION OF THE INVENTION

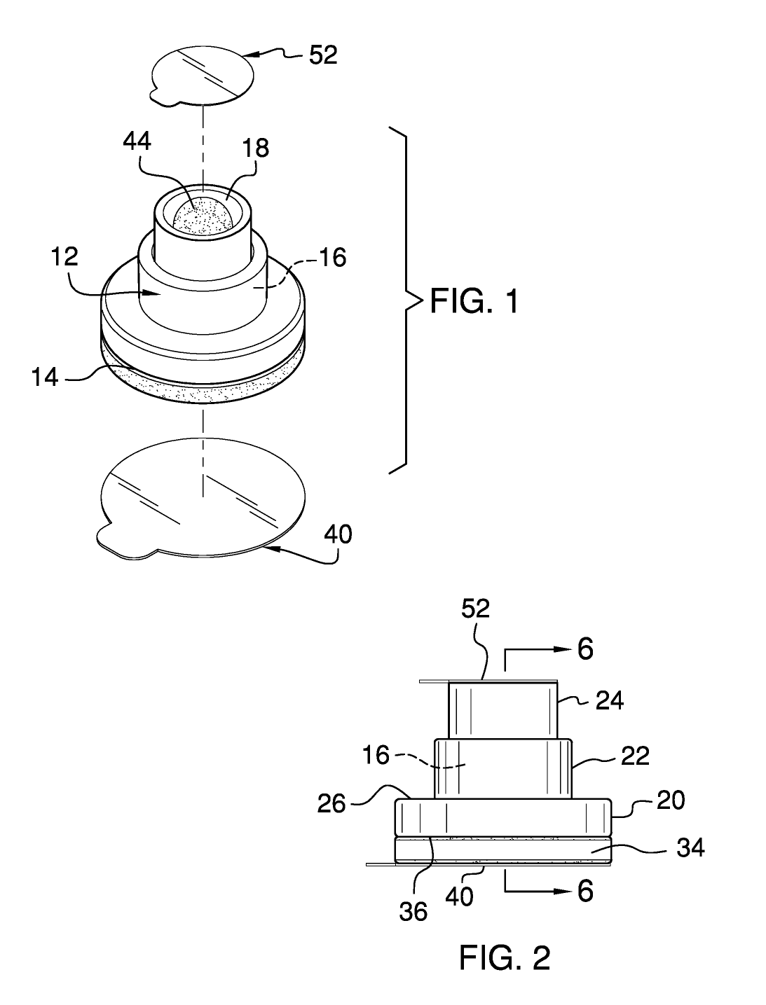

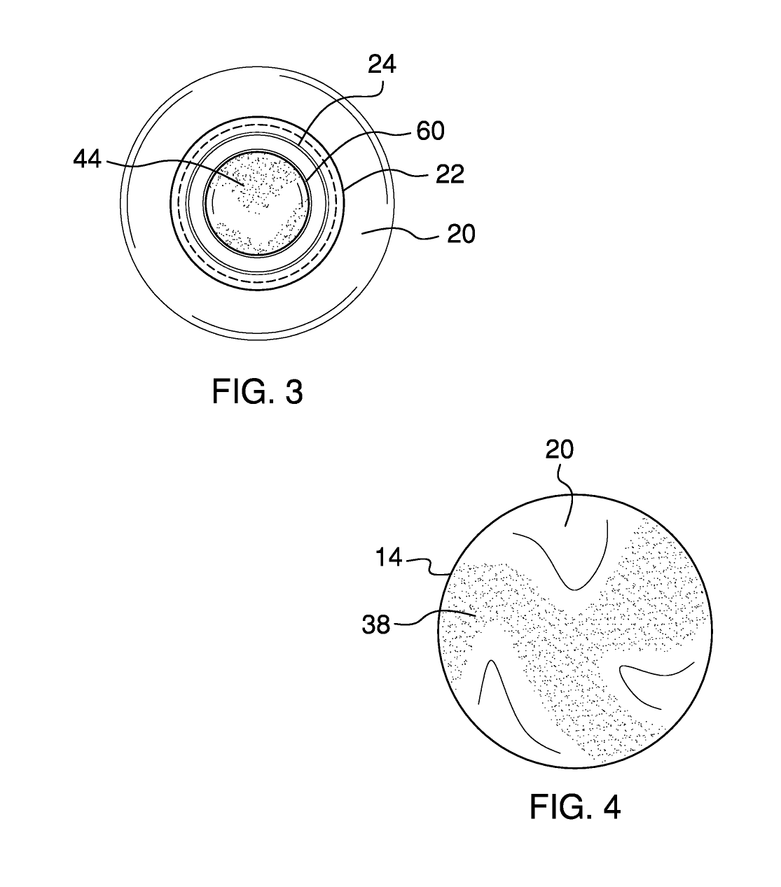

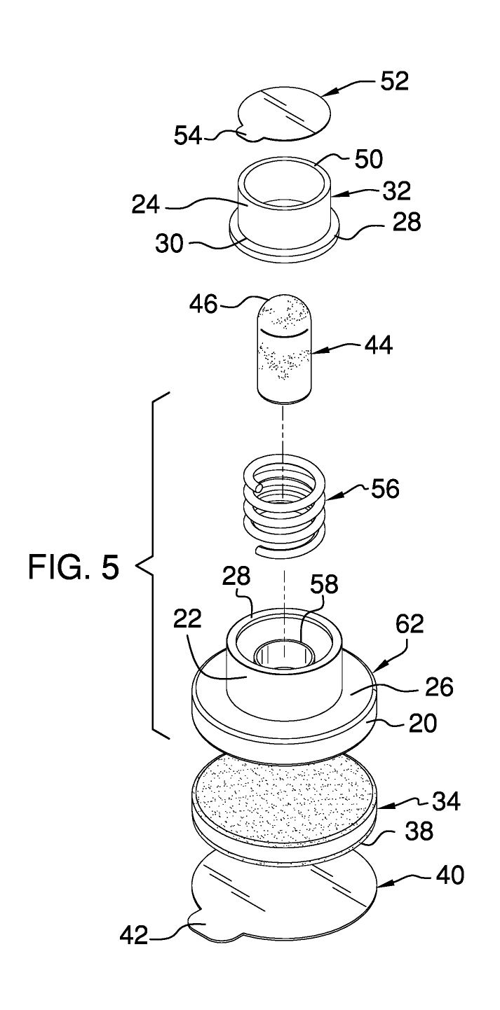

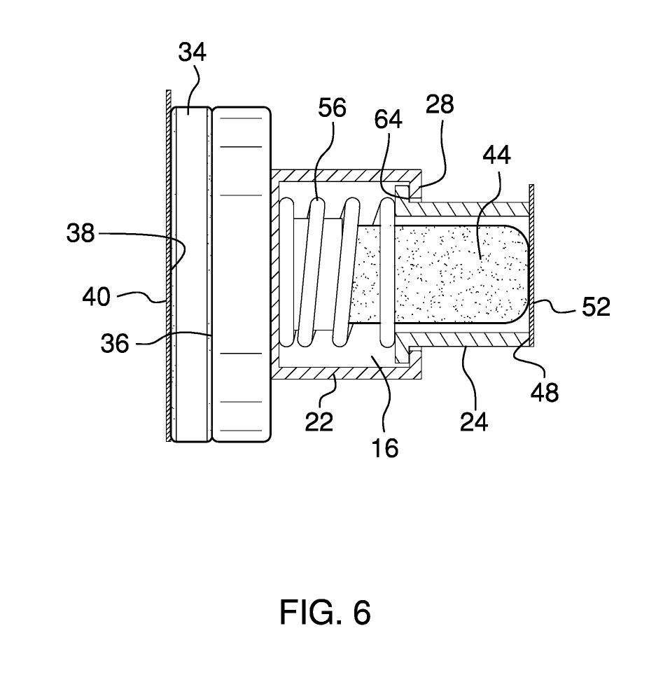

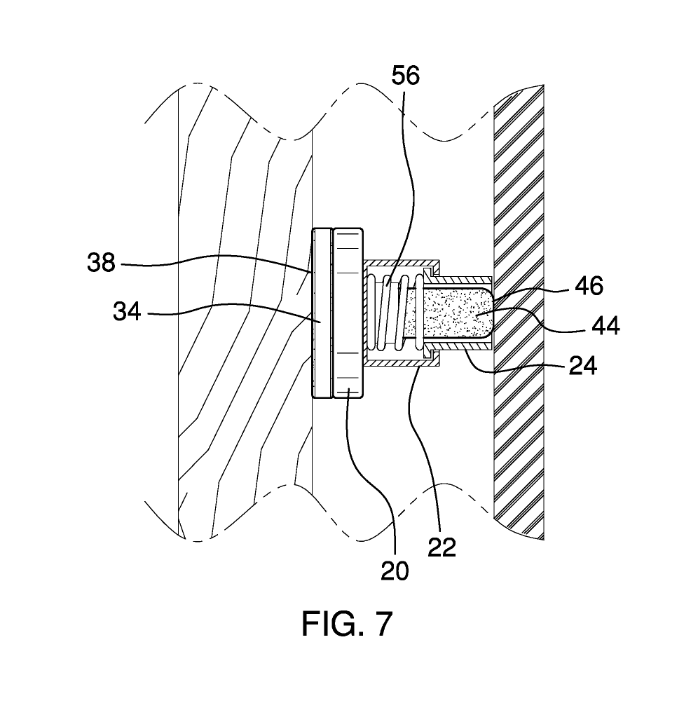

With reference now to the drawings, and in particular to FIGS. 1 through 7 thereof, a new guide device embodying the principles and concepts of an embodiment of the disclosure and generally designated by the reference numeral 10 will be described.

As best illustrated in FIGS. 1 through 7, the frame hanging guide device 10 generally comprises a housing 12 that is configured to reversibly couple by a first end 14 to a back of a frame, such as picture frame. The housing 12 defines an interior space 16. The housing 12 has a second end 18 that is open.

The housing 12 comprises a base 20, a first cylinder 22, and a second cylinder 24. The first cylinder 22 is coupled to and extends from a first face 26 of the base 20. The second cylinder 24 slidably positionable within the first cylinder 22. The first cylinder 22 and the second cylinder 24 are open-ended. A first lip 28 is coupled to and extends inwardly from the first cylinder 22 distal from the base 20. A second lip 64 is coupled to and extends outwardly from a lower perimeter 30 of the second cylinder 24. The second cylinder 24 is positioned to contact the first lip 28 to retain the second cylinder 24 within the first cylinder 22. In one embodiment, the base 20 is circularly shaped. In another embodiment, the second cylinder 24 and the second lip 64 comprise a second plastic mold 32. The second plastic mold 32 is sonic welded.

A tape 34 is adhesively coupled to a second face 36 of the base 20. The tape 34 is shaped complementarily to the second face 36. A first adhesive 38 is positioned on the tape 34. The first adhesive 38 is opposingly positioned relative to the base 20. The first adhesive 38 is configured to reversibly couple the housing 12 to the frame.

In one embodiment, a first panel 40 is coupled to the first adhesive 38. The first panel 40 is complementary to the tape 34. The first panel 40 is flexible. The first panel 40 is reversibly couplable to the first adhesive 38. The first panel 40 is configured to be selectively decoupled from the first adhesive 38 so that the first adhesive 38 is configured to reversibly couple the housing 12 to the frame. In another embodiment, a first tab 42 is coupled to and extends coplanarly from the first panel 40. The first tab 42 is configured to be grasped in digits of a hand of a user to selectively decouple the first panel 40 from the first adhesive 38 so that the first adhesive 38 is configured to reversibly couple the housing 12 to the frame.

An indicator 44 is positioned in the interior space 16. The indicator 44 is selectively extensible from the housing 12. The indicator 44 is configured to mark an attachment point on a surface as the frame is positioned in a desired location on the surface. An article of mounting hardware can be coupled to the surface at the attachment point to hang the frame. In one embodiment, the indicator 44 comprises ink-impregnated felt. In another embodiment, the indicator 44 is substantially cylindrically shaped. The indicator 44 has a top 46. In yet another embodiment, the top 46 is rounded.

A second adhesive 48 is coupled to an upper perimeter 50 of the second cylinder 24. A second panel 52 is coupled to the second adhesive 48. The second panel 52 is complementary to the second end 18 of the housing 12. The second panel 52 is flexible. The second panel 52 is positioned to seal the indicator 44 within the interior space 16. The second panel 52 is reversibly couplable to the second adhesive 48. The second panel 52 is configured to be selectively decoupled from the second adhesive 48 so that the indicator 44 is positioned to selectively extend from the housing 12.

In one embodiment, a second tab 54 is coupled to and extends coplanarly from the second panel 52. The second tab 54 is configured to be grasped in the digits of the hand of the user to selectively decouple the second panel 52 from the second adhesive 48 so that the indicator 44 is positioned to selectively extend from the housing 12.

A spring 56 extends between the second lip 64 and the first face 26 of the base 20. The spring 56 is positioned around the indicator 44. The spring 56 is positioned in the first cylinder 22. The second cylinder 24 is biased to an extended configuration wherein the second lip 64 abuts the first lip 28. The second cylinder 24 is positioned to compress the spring 56 as the frame is positioned in the desired location on the surface. The top 46 of the indicator 44 is configured to contact the surface to mark the attachment point on the surface.

A coupler 58 is coupled to the housing 12 and is positioned within the interior space 16. The coupler 58 is configured to couple to the indicator 44. The coupler 58 is positioned to couple to the indicator 44 to couple the indicator 44 to the housing 12 and to position the indicator 44 within the interior space 16. In one embodiment, the coupler 58 comprises a third cylinder 60. The third cylinder 60 is open-ended. The third cylinder 60 is positioned to insert the indicator 44 to frictionally couple the indicator 44 to the housing 12 and to position the indicator 44 within the interior space 16. In another embodiment, the third cylinder 60, the first cylinder 22, and the base 20 comprises a first plastic mold 62. The first plastic mold 62 is sonic welded.

In use, the first tab 42 is configured to be grasped in the digits of the hand of the user to selectively decouple the first panel 40 from the first adhesive 38. The first adhesive 38 is configured to reversibly couple the housing 12 to the frame. The second panel 52 is positioned to seal the indicator 44 within the interior space 16. The second tab 54 is configured to be grasped in the digits of the hand of the user to selectively decouple the second panel 52 from the second adhesive 48. The indicator 44 is positioned to selectively extend from the housing 12. The second cylinder 24 is positioned to contact the first lip 28 to retain the second cylinder 24 within the first cylinder 22. The second cylinder 24 is biased by the spring 56 to the extended configuration wherein the second lip 64 abuts the first lip 28. The second cylinder 24 is positioned to compress the spring 56 as the frame is positioned in the desired location on the surface. The top 46 of the indicator 44 is configured to contact the surface to mark the attachment point on the surface. The article of mounting hardware can be coupled to the surface at the attachment point to hang the frame.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A frame hanging guide device comprising:
a housing configured for reversibly coupling by a first end to a back of a frame, such as picture frame, said housing defining an interior space, said housing having a second end, said second end being open;
an indicator positioned in said interior space, said indicator being selectively extensible from said housing; and
wherein said indicator is positioned in said housing such that said indicator is configured for marking an attachment point on a surface as the frame is positioned in a desired location on the surface, such that an article of mounting hardware can be coupled to the surface at the attachment point for hanging the frame.

2. The device of claim 1, further including said housing comprising:
a base;
a first cylinder coupled to and extending from a first face of said base, said first cylinder being open-ended;
a second cylinder slidably positionable within said first cylinder, said second cylinder being open-ended;
a first lip coupled to and extending inwardly from said first cylinder distal from said base;
a second lip coupled to and extending outwardly from a lower perimeter of said second cylinder; and
wherein said second lip is positioned on said second cylinder such that said second cylinder is positioned for contacting said first lip for retaining said second cylinder within said first cylinder.

3. The device of claim 2, further including said base being circularly shaped.

4. The device of claim 2, further including said second cylinder and said second lip comprising a second plastic mold, said second plastic mold being sonic welded.

5. The device of claim 2, further comprising:
a tape adhesively coupled to a second face of said base, said tape being shaped complementarily to said second face;
a first adhesive positioned on said tape, said first adhesive being opposingly positioned relative to said base; and
wherein said first adhesive is positioned on said tape such that said first adhesive is configured for reversibly coupling said housing to the frame.

6. The device of claim 5, further including a first panel complementary to said tape, said first panel being flexible, said first panel being coupled to said first adhesive, said first panel being reversibly couplable to said first adhesive, wherein said first panel is positioned on said first adhesive such that said first panel is configured selectively decoupling from said first adhesive such that said first adhesive is configured for reversibly coupling said housing to the frame.

7. The device of claim 6, further including a first tab coupled to and extending coplanarly from said first panel, wherein said first tab is positioned on said first panel such that said first tab is configured for grasping in digits of a hand of a user for selectively decoupling said first panel from said first adhesive such that said first adhesive is configured for reversibly coupling said housing to the frame.

8. The device of claim 1, further including said indicator comprising ink-impregnated felt.

9. The device of claim 2, further including said indicator being substantially cylindrically shaped.

10. The device of claim 10, further including said indicator having a top, said top being rounded.

11. The device of claim 2, further comprising:
a second adhesive coupled to an upper perimeter of said second cylinder;
a second panel complementary to said second end of said housing, said second panel being flexible, said second panel being coupled to said second adhesive, said second panel being reversibly couplable to said second adhesive; and
wherein said second panel is positioned on said housing such that said second panel is positioned for sealing said indicator within said interior space, wherein said second panel is positioned on said second adhesive such that said second panel is configured for selectively decoupling from said second adhesive such that said indicator is positioned for selectively extending from said housing.

12. The device of claim 11, further including a second tab coupled to and extending coplanarly from said second panel, wherein said second tab is positioned on said second panel such that said second tab is configured for grasping in digits of a hand of a user for selectively decoupling said second panel from said second adhesive such that said indicator is positioned for selectively extending from said housing.

13. The device of claim 9, further including a spring extending between said second lip and said first face of said base, said spring being positioned around said indicator, wherein said spring is positioned in said first cylinder such that said second cylinder is biased to an extended configuration wherein said second lip abuts said first lip and wherein said second cylinder is positioned for compressing said spring as the frame is positioned in the desired location on the surface, such that said top of said indicator is configured for contacting the surface for marking the attachment point on the surface.

14. The device of claim 9, further including a coupler coupled to said housing and positioned within said interior space, said coupler being configured for coupling to said indicator, wherein said coupler is positioned on said housing such that said coupler is positioned for coupling to said indicator for coupling said indicator to said housing and positioning said indicator within said interior space.

15. The device of claim 14, further including said coupler comprising a third cylinder, said third cylinder being open-ended, wherein said third cylinder is positioned on said housing such that said third cylinder is positioned for inserting said indicator for frictionally coupling said indicator to said housing and positioning said indicator within said interior space.

16. The device of claim 15, further including said third cylinder, said first cylinder and said base comprising a first plastic mold, said first plastic mold being sonic welded.

17. A frame hanging guide device comprising:
a housing configured for reversibly coupling by a first end to a back of a frame, such as picture frame, said housing defining an interior space, said housing having a second end, said second end being open, said housing comprising:
a base, said base being circularly shaped,
a first cylinder coupled to and extending from a first face of said base, said first cylinder being open-ended,
a second cylinder slidably positionable within said first cylinder, said second cylinder being open-ended,
a first lip coupled to and extending inwardly from said first cylinder distal from said base, and
a second lip coupled to and extending outwardly from a lower perimeter of said second cylinder, wherein said second lip is positioned on said second cylinder such that said second cylinder is positioned for contacting said first lip for retaining said second cylinder within said first cylinder, said second cylinder and said second lip comprising a second plastic mold, said second plastic mold being sonic welded;
a tape adhesively coupled to a second face of said base, said tape being shaped complementarily to said second face;
a first adhesive positioned on said tape, said first adhesive being opposingly positioned relative to said base, wherein said first adhesive is positioned on said tape such that said first adhesive is configured for reversibly coupling said housing to the frame;
a first panel complementary to said tape, said first panel being flexible, said first panel being coupled to said first adhesive, said first panel being reversibly couplable to said first adhesive, wherein said first panel is positioned on said first adhesive such that said first panel is configured selectively decoupling from said first adhesive such that said first adhesive is configured for reversibly coupling said housing to the frame;
a first tab coupled to and extending coplanarly from said first panel, wherein said first tab is positioned on said first panel such that said first tab is configured for grasping in digits of a hand of a user for selectively decoupling said first panel from said first adhesive such that said first adhesive is configured for reversibly coupling said housing to the frame;
an indicator positioned in said interior space, said indicator being selectively extensible from said housing, wherein said indicator is positioned in said housing such that said indicator is configured for marking an attachment point on a surface as the frame is positioned in a desired location on the surface, such that an article of mounting hardware can be coupled to the surface at the attachment point for hanging the frame, said indicator comprising ink-impregnated felt, said indicator being substantially cylindrically shaped, said indicator having a top, said top being rounded;
a second adhesive coupled to an upper perimeter of said second cylinder;
a second panel complementary to said second end of said housing, said second panel being flexible, said second panel being coupled to said second adhesive, wherein said second panel is positioned on said housing such that said second panel is positioned for sealing said indicator within said interior space, said second panel being reversibly couplable to said second adhesive, wherein said second panel is positioned on said second adhesive such that said second panel is configured for selectively decoupling from said second adhesive such that said indicator is positioned for selectively extending from said housing;
a second tab coupled to and extending coplanarly from said second panel, wherein said second tab is positioned on said second panel such that said second tab is configured for grasping in the digits of the hand of the user for selectively decoupling said second panel from said second adhesive such that said indicator is positioned for selectively extending from said housing;
a spring extending between said second lip and said first face of said base, said spring being positioned around said indicator, wherein said spring is positioned in said first cylinder such that said second cylinder is biased to an extended configuration wherein said second lip abuts said first lip and wherein said second cylinder is positioned for compressing said spring as the frame is positioned in the desired location on the surface, such that said top of said indicator is configured for contacting the surface for marking the attachment point on the surface;
a coupler coupled to said housing and positioned within said interior space, said coupler being configured for coupling to said indicator, wherein said coupler is positioned on said housing such that said coupler is positioned for coupling to said indicator for coupling said indicator to said housing and positioning said indicator within said interior space, said coupler comprising a third cylinder, said third cylinder being open-ended, wherein said third cylinder is positioned on said housing such that said third cylinder is positioned for inserting said indicator for frictionally coupling said indicator to said housing and positioning said indicator within said interior space, said third cylinder, said first cylinder and said base comprising a first plastic mold, said first plastic mold being sonic welded; and
wherein said first tab is positioned on said first panel such that said first tab is configured for grasping in the digits of the hand of the user for selectively decoupling said first panel from said first adhesive such that said first adhesive is configured for reversibly coupling said housing to the frame, wherein said second panel is positioned on said housing such that said second panel is positioned for sealing said indicator within said interior space, wherein said second tab is positioned on said second panel such that said second tab is configured for grasping in the digits of the hand of the user for selectively decoupling said second panel from said second adhesive such that said indicator is positioned for selectively extending from said housing, wherein said second lip is positioned on said second cylinder such that said second cylinder is positioned for contacting said first lip for retaining said second cylinder within said first cylinder, wherein said spring is positioned in said first cylinder such that said second cylinder is biased to the extended configuration wherein said second lip abuts said first lip, wherein said second cylinder is positioned for compressing said spring as the frame is positioned in the desired location on the surface, such that said top of said indicator is configured for contacting the surface for marking the attachment point on the surface, such that the article of mounting hardware can be coupled to the surface at the attachment point for hanging the frame.
